(19) United States
(12) Patent Application Publication
(10) Pub. No.: US 2023/0298225 A1
(43) Pub. Date: Sep. 21, 2023

(54) SYSTEMS, DEVICES, COMPONENTS, AND METHODS FOR OPTIMIZING INFORMATION AND DATA ACQUISITION, TRANSMISSION, PROCESSING, AND ANALYSIS

(71) Applicants: CENTRO NACIONAL DE PESQUISA EM ENERGIA E MATERIAIS, Campinas (BR); IMAGE SCIENCE SOFTWARE GMBH, Berlin (DE)

(72) Inventors: Marin Gerard VAN HEEL, Campinas (BR); Michael SCHATZ, Berlin (DE)

(21) Appl. No.: 18/024,225

(22) PCT Filed: Sep. 1, 2021
(86) PCT No.: PCT/BR2021/050375

§ 371 Date: Mar. 1, 2023

(30) Foreign Application Priority Data
Sep. 2, 2020 (US) 63073736

(51) Int. Cl. G06T 11/00; G06T 3/40; G06T 19/20

(52) U.S. Cl. CPC G06T 11/001; G06T 3/40; G06T 19/20; G06T 2200/24; G06T 2219/2012

(57) ABSTRACT

Disclosed are various examples and embodiments of systems, devices, components and methods configured to calculate the information content of data and information, which in some embodiments are based on new metrics integrating the real space and Fourier space properties of the data or information collected. Among other things, these systems, devices, components and methods provide an assessment of a full information collection chain; the information content of data in a harvesting experiment; global and local resolution; and the information content within objects of interest. Information and data metrics are measured in “bits”. The disclosed systems, devices, components and methods fall within the fields of information processing, information theory, digital signal processing, image processing, image analysis, channel capacity, signal transducers, and analogous fields, and include within their scope computing devices exploiting the new signal processing techniques and algorithms.

### FIELD OF THE INVENTION

Various embodiments described and disclosed herein relate, but are not necessarily limited, to the fields of information and data processing, information theory, digital signal processing, image processing, image analysis, channel capacity, and signal transducers.

### BACKGROUND

The recording of new information and the processing of that data are fundamental procedures in augmenting the information and knowledge available to mankind.

The most frequently used metrics in information processing are the Signal-to-Noise Ratio (SNR) and the associated Shannon-Hartley channel capacity. Those metrics are focused on not losing a known signal, already contained in a message, while transferring the message through a “channel”.

The Signal-to-Noise ratio (SNR) of a dataset is defined as the ratio of the signal power over the noise power, i.e., SNR =s²/n². The SNR is either known a priori, or can otherwise only be estimated, since the signal cannot be measured separately from the noise in an incoming measurement. The SNR concept originated primarily in electrical engineering and was designed to quantify how well a channel (e.g. a telegraph line, or a telephone line) transports a known input signal to its output, in spite of noise sources deteriorating that signal underway. In other words, the popular SNR is associated with the loss of information when a known signal is transmitted through a channel.

The fact that the SNR is a positive function already indicates that one assumes a priori that there is a signal at the input of the channel. Conversely, in data-harvesting the measurements are very noisy and it should be determined whether there is some systematic signal hidden in that noise. That is, there is no significant knowledge of the information to be collected.

These metrics therefore require complete prior knowledge of the signal. They are not compatible with the concept of collecting hitherto unknown information.

Cross-correlations are useful functions for searching similarities and detecting novel information. Cross-correlation coefficients (CCCs) are often used for comparing two (or more) independent real space measurements from the same source. However, such metrics are often of limited use in real space. In normal images, for example, the prevalence of low-frequency components can be so overwhelming that CCCs become indiscriminate and don't correctly reflect the important high-frequency details in, say, images [Van Heel, 1992—see “References” in “Information: to Harvest, to Have and to Hold” to van Heel et al., attached hereto in Appendix A].

Fourier space metrics like the Fourier Ring Correlation (FRC) [Van Heel, 1982, ibid] and the Fourier Shell Correlation (FSC) [Harauz and van Heel, 1986, ibid] are cross correlation metrics assessed in Fourier space as function of spatial frequency, that is, over rings in 2D Fourier space (FRC) or over shells in 3D Fourier space. The resulting FRC and FSC cross-correlation coefficients are neither SNRs nor are they “information” in the Shannon's sense. The values of FSC/FRC metrics do increase when we sum more noisy data into the measurements, but a fundamental problem remains: how to integrate those FSC/FRC metrics into the world of SNRs and of Shannon's information concepts.

The theory of linear information transfer in 2D, or 3D, or 1D, still requires a metric stating how much information has actually been collected during an experiment.

With our new Fourier space information algorithms, we introduce a new metric to the theory of linear information transfer in 2D, or 1D, or 3D, stating how much information has actually been collected during an experiment at the output of a “channel”, as function of spatial frequency. Other aspects are also described and disclosed herein.

### SUMMARY

In one embodiment, there is provided a system configured to provide as at least one information content output therefrom at least one representation or visualization of, or data, data set, or signals corresponding to, information content contained in two or more images of, two or more image signals or sets of image signals, or two or more image data or image data sets associated with, at least one object, where the system comprises: (a) at least one computing device, and (b) at least one of a data acquisition device, a sensor, and a transducer operably connected to the at least one computing device or configured to provide as outputs therefrom first and second acquisition signals, first and second acquisition data, or first and second acquisition data sets corresponding to at least first and second input images of, first and second input signals, or first and second input data associated with imaging, the object; wherein the computing device comprises at least one non-transitory computer readable medium configured to store instructions executable by at least one processor to generate the at least one information content output, the computing device being configured to: (i) receive the first and second acquisition signals, the first and second acquisition data, or the first and second acquisition data sets as first and second input data sets thereto; (ii) perform respective Fourier transforms over at least portions of the first and second input data sets to generate respective first and second Fourier transformed data sets; (iii) evaluate at least portions of at least one of the first and second transformed data set using information content determination algorithm to generate output comparative metrics, information or data representative of the differences between data, compared data, or correlated data contained in the first and second transformed data sets as the information content output.

Such an embodiment may further comprise one or more of: (a) the information content algorithm is being real space information content algorithm; (b) at least one of the first and second input data sets comprising one or more of a one-dimensional data set, a two-dimensional data set, a three-dimensional data set, and an multi-dimensional data set; (c) at least one of the first and second input data sets comprising a Fourier transformed data set; (d) the system being further configured to provide a visual representation to a user of the information content output; (e) the visual representation provided to the user being colour coded to represent differences in the visualized information content output; (f) the differences in the visualized representation corresponding to changes in properties or characteristics of the object; (g) the properties or characteristics being one or more of biological, physical, chemical, magnetic, nuclear, and structural; (h) the system being further configured to permit a user to selectably change information content thresholds in the information content output; (i) the system being further configured to permit a user to selectably change colours in the information content output; (j) the system being further configured to align at least portions of the first and second input data sets before generating the first and second transformed data sets; (k) the system further comprising: (c) a display, screen, or monitor operably connected to the at least one computing device and configured to visually display to a user the at least one representation of, or data, data set, or signals corresponding to, at least portions of the information content output; (l) the system being further configured to estimate one or more resolutions of at least one or more portions of the sum of the first and second input images, or the sum of first and second input data, using at least portions of the information content output; (m) the estimated resolutions being global or local; (n) the system being further configured to estimate a quality or efficiency of at least one of the data acquisition device, the sensor, and the transducer using at least portions of the information content output; (o) the system being further configured with at least one of the data acquisition device, the sensor, and the transducer using at least portions of the information content output; (p) the system being further configured to use at least portions of the information content output to generate one or more updated, refined, or processed representations of the one or more images of, the image signals or sets of image signals, or the image data or the image data sets associated with, the at least one object; (q) the system being further configured to generate at least one Transducer Information Efficiency (TIE) metric for the data acquisition device, the sensor, or the transducer using at least partially the generated information content output; (r) the TIE metric being calculated using the formula for 2D images:

$$TIE ( {r}_{i} ) = \frac{{FRI}_{o u t} ( {r}_{i} )}{{FRI}_{i n} ( {r}_{i} )} ;$$

(s) the information content FRI determination algorithm FRI for 2D images employing the formula

$${FRI}_{12} ( {r}_{i} ) = K \cdot {log}_{2} \{ \frac{1 + F R {C}_{12} ( {r}_{i} )}{1 - F R {C}_{12} ( {r}_{i} )} \} ;$$

(t) the TIE metric being calculated using the formula for 3D volumetric transducers

$$TIE ( {r}_{i} ) = \frac{{FSI}_{o u t} ( {r}_{i} )}{{FSI}_{i n} ( {r}_{i} )} ;$$

(u) the information content FSI determination algorithm for 3D volumes employing the formula:

$${FSI}_{12} ( {r}_{i} ) = K \cdot {log}_{2} \{ \frac{1 + F S {C}_{12} ( {r}_{i} )}{1 - F S {C}_{12} ( {r}_{i} )} \}$$

(v) the system being adapted and configured for use in one or more of the following applications: (a) electron microscopy; (b) light microscopy (c) atomic force microscopy (d) other microscopies (e) photography; (f) medical imaging, including X-ray imaging, MRI, MT, NMR, and CAT-scan imaging; (g) geophysical data processing, including seismic data processing; (h) remote sensing, including remote earth sensing; (i) information communication, including optical fibre, electromagnetic, magnetic, electrical, radio, wired, wireless, LAN, WAN, and internet applications; (j) image processing; (k) image analysis; (l) image display; (m) information or data processing; (n) information or data analysis; and (o) information of data display.

In another embodiment, there is provided a method of providing at least one information content output, the information content output comprising one or more of at least one representation or visualization of, or data, data set, or signals corresponding to, information content contained in at least two or more images of, two or more image signals or sets of image signals, or two or more image data or image data sets associated with, at least one object, the method comprising: (a) receiving as first and second input data sets to a computing device first and second data acquisition signals, first and second data acquisition data, or first and second data acquisition data sets corresponding at least to first and second input images of, first and second input signals, or first and second input data or data sets associated with, imaging at least one object, the inputs being provided by at least one of a data acquisition device, a sensor, and a transducer, or data or data sets corresponding to the device, sensor or transducer;(b) executing instructions stored in at least one non-transitory computer readable medium included in the computing device to generate the at least one information content output, the computing device being configured to: (i) receive the first and second acquisition signals, the first and second acquisition data, or the first and second acquisition data sets as first and second input data sets thereto; (ii) perform respective Fourier transforms over at least portions of the first and second input data sets to generate respective first and second Fourier transformed data sets; and (iii) evaluate at least portions of at least one of the first and second transformed data sets using an information content determination algorithm to generate output comparative metrics, information or data representative of the differences between data, compared data, or correlated data contained in the first and second Fourier transformed data sets as the information content output.

Such an embodiment may further comprise one or more of: (a) the information content algorithm being a real space information content algorithm; (b) at least one of the first and second input data sets comprising one or more of a one-dimensional data set, a two-dimensional data set, a three-dimensional data set, and an multi-dimensional data set; (c) at least one of the first and second input data sets comprising a Fourier transformed data set; (d) further comprising providing a visual representation to a user of the information content output; (e) the visual representation provided to the user being colour coded to represent differences in the visualized information content output; (f) the differences in the visualized representation corresponding to changes in properties or characteristics of the object; (g) the properties or characteristics being one or more of biological, physical, chemical, magnetic, nuclear, and structural; (h) further comprising selectably changing information content thresholds in the information content output; (i) further comprising selectably changing colours in the information content output; (j) further comprising aligning at least portions of the first and second input data sets before generating the first and second Fourier transformed data sets; (k) further comprising visually displaying the at least one representation of, or data, data set, or signals corresponding to, at least portions of the information content output; (l) further comprising estimating one or more resolutions of at least one of the first and second input images, or the first and second input data, using at least portions of the information content output; (m) further comprising estimating one or more global or local resolutions of at least one of the first and second input images or the first and second input data using at least portions of the information content output; (n) further comprising estimating a quality or efficiency of at least one of the data acquisition device, the sensor, and the transducer using at least portions of the information content output; (o) further comprising estimating at least one transfer function associated with at least one of the data acquisition device, the sensor, and the transducer using at least portions of the information content output; (p) further comprising using at least portions of the information content output to generate one or more updated, refined, or processed representations of the one or more images of, the image signals or sets of image signals, or the image data or the image data sets associated with, the at least one object; (q) further comprising generating at least one Transducer Information Efficiency (TIE) metric for the data acquisition device, the sensor, or the transducer using at least partially the generated information content output; (r) further comprising calculating the TIE metric using the formula for images:

$$TIE ( {r}_{i} ) = \frac{{FRI}_{o u t} ( {r}_{i} )}{{FRI}_{i n} ( {r}_{i} )}$$

(s) the information content FRI determination algorithm being two-dimensional and employing the formula:

$${FRI}_{12} ( {r}_{i} ) = K \cdot {log}_{2} \{ \frac{1 + F R {C}_{12} ( {r}_{i} )}{1 - F R {C}_{12} ( {r}_{i} )} \}$$

(t) further comprising calculating the TIE metric using the formula for volumes:

$$TIE ( {r}_{i} ) = \frac{{FSI}_{o u t} ( {r}_{i} )}{{FSI}_{i n} ( {r}_{i} )}$$

(u) the information content FSI determination algorithm employing the formula for volumes:

$${FSI}_{12} ( {r}_{i} ) = K \cdot {log}_{2} \{ \frac{1 + F S {C}_{12} ( {r}_{i} )}{1 - F S {C}_{12} ( {r}_{i} )} \}$$

and (v) further comprising adapting and configuring the method for use in one or more of the following applications: (a) electron microscopy; (b) light microscopy (c) atomic force microscopy (d) other microscopies (e) photography; (f) medical imaging, including X-ray imaging, MRI, MT, NMR, and CAT-scan imaging; (g) geophysical data processing, including seismic data processing; (h) remote sensing, including remote earth sensing; (i) information communication, including optical fibre, electromagnetic, magnetic, electrical, radio, wireless, LAN, WAN, and internet applications.

Further embodiments are disclosed herein or will become apparent to those skilled in the art after having read and understood the claims, specification and drawings hereof.

### BRIEF DESCRIPTION OF THE DRAWINGS

The patent or application file contains at least one drawing executed in colour. Copies of this patent or patent application publication with colour drawing(s) will be provided by the Office upon request and payment of the necessary fee.

Different aspects of the various embodiments will become apparent from the following specification, drawings and claims in which:

FIG. 1 shows a flowchart describing one embodiment of a method or algorithm using Fourier space metrics for global comparison;

FIG. 2 shows a flowchart describing one embodiment of a method or algorithm using Fourier space metrics for global comparison, and details steps involving hardware and software;

FIG. 3 shows a flowchart describing one embodiment of a method or algorithm for local comparison;

FIG. 4 shows a flowchart describing one embodiment of a method or algorithm for local comparison, and details steps involving hardware and software;

FIG. 5 shows a flowchart describing one embodiment of a method or algorithm using Fourier space metrics for assessing camera/detector transducer information efficiency, and using it as a metric for camera/detector/transducer quality;

FIG. 6 shows a flowchart describing one embodiment of a method or algorithm using Fourier space metrics to globally compare data and/or estimate global resolution;

FIG. 7 shows a flowchart describing one embodiment of a method or algorithm of using Fourier space metrics to globally compare data and/or estimate global resolution or global integrated information content of an object, and details steps involving hardware and software;

FIG. 8 shows a flowchart describing one embodiment of a method or algorithm using Fourier space metrics to locally compare information density and/or estimate local resolution;

FIG. 9 shows a flowchart describing one embodiment of a method or algorithm using Fourier space metrics to locally compare data based on local information density and/or to estimate local resolution, and details steps involving hardware and software;

FIG. 10 shows one embodiment of FSI curves, showing a flowchart of the behaviour as function of the data set size;

FIG. 11 shows one embodiment of r-weighted FSI curves, which show information content as a function of spatial frequency;

FIGS. 12 and 13 are comparative examples of the behaviour of FSC curves as function of the data set size;

FIG. 14 shows one embodiment of Fourier Ring Information FRI for two different cryo-EM cameras using the same test sample, where both cameras were mounted on the same microscope;

FIG. 15 shows one embodiment of Fourier space comparisons using Transducer Information Efficiency TIE, and further shows that different exposure times can lead to different information content in detected images;

FIG. 16 shows one embodiment of “guiFSC” software configured to calculate global and local information comparisons, and also shows a section of a cryo-EM three-dimensional density of a pathogenic human virus, and

FIG. 17 shows one embodiment of a section of the three-dimensional density shown in FIG. 16, with local information/resolution imposed as colours, where different colours represent different local information/resolution.

The drawings are not necessarily to scale. Like numbers refer to like parts or steps throughout the drawings.

### DETAILED DESCRIPTIONS OF SOME EMBODIMENTS

Described herein are various embodiments of systems, devices, components, and methods for optimizing information and data acquisition, transmission, processing, and analysis.

The information and figures provided herein are further expanded upon, explained, and supplemented by the two documents attached hereto in Appendix A (“Information: to Harvest, to Have and to Hold” to van Heel et al.) and Appendix B (“Information and Glycosylation Interface between Physics and Biology” to van Heel et al.), neither of which documents has ever been publicly disclosed, published, or distributed prior to the filing of the present provisional patent application with the United States Patent & Trademark Office on even date herewith.

The New Metrics

The new Fourier based information techniques described and disclosed herein are based on Fourier Shell Correlation (FSC) in 3D or on Fourier Ring Correlation (FRC) in 2D, respectively. The FRC/FSC is a cross-correlation coefficient, in which the cross correlation is normalized by the square root of the power in the corresponding rings/shells in Fourier space. In one embodiment, the FSC or FRC may be defined as:

$$F S {C}_{12} ( {r}_{i} ) = \frac{{\sum }_{r ∈ {r}_{i}} {F}_{1} ( r ) \cdot {F}_{2}^{*} ( r )}{\sqrt{{\sum }_{r ∈ {r}_{i}} {\vert {F}_{1} ( r ) \vert}^{2} \cdot {\sum }_{r ∈ {r}_{i}} {\vert {F}_{2} ( r ) \vert}^{2}}}$$

According to some embodiments, the new Fourier based information metrics may be defined as follows:
a) 2D: Fourier Ring Information

$${FRI}_{12} ( {r}_{i} ) = {K}_{r} \cdot {log}_{2} \{ \frac{1 + F R {C}_{12} ( {r}_{i} )}{1 - F R {C}_{12} ( {r}_{i} )} \}$$

wherein:
   FRC is the Fourier Ring Correlation between the two given rings, in Fourier space, at radius rᵢ
   Kᵣ is in this 2D case defined as

Kᵣ=K·rᵢ
b) 3D: Fourier Shell Information:

$${FSI}_{12} ( {r}_{i} ) = {K}_{r} \cdot {log}_{2} \{ \frac{1 + F S {C}_{12} ( {r}_{i} )}{1 - F S {C}_{12} ( {r}_{i} )} \}$$

wherein:
   FSC₁₂ is the Fourier Shell Correlation between the two shells in Fourier space at radius rᵢ
   Kᵣ is, in this 3D case, defined as

Kᵣ=K·rᵢ²
c) 1D: Channel information capacity

$$PIC = B \cdot {log}_{2} \{ \frac{1 + C C {C}_{12}}{1 - C C {C}_{12}} \}$$

wherein:
   PIC is the packet information capacity;
   B is the maximum bandwidth in Fourier space; and
   CCC is the cross-correlation coefficient between two measurements in real space
d) Metric for assessing transducer quality, the Transducer Information efficiency:

$$TIE ( {r}_{i} ) = \frac{{FRI}_{o u t} ( {r}_{i} )}{{FRI}_{i n} ( {r}_{i} )}$$

To compare two transducers/cameras, placed in otherwise identical instrumental environments, we use the relative TIE:

$${TIE}_{R E L 12} ( {r}_{i} ) = \frac{{FRI}_{O U T 1} ( {r}_{i} )}{{FRI}_{O U T 2} ( {r}_{i} )}$$

Example Pseudo Code for the New Metrics

Provided below is one embodiment of pseudo code that can be employed in the new metrics. The pseudo code example shown below is merely illustrative and not intended to be limiting.
a) Global information—(aspect 1) and global resolution comparison (aspect 2):

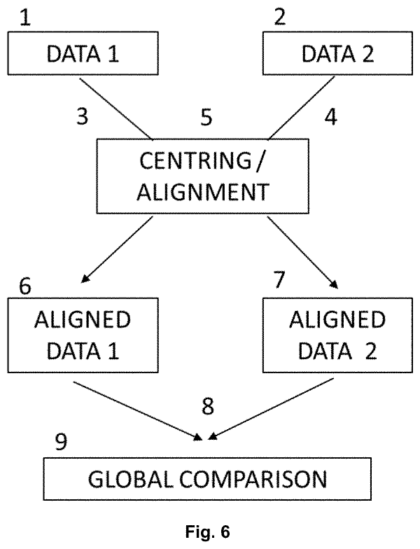

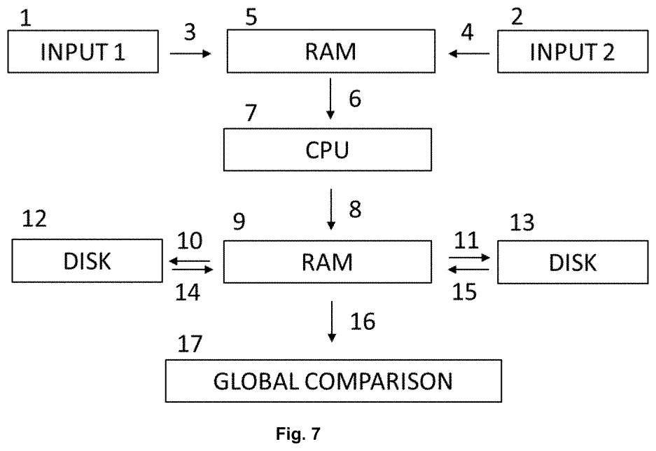

```
// program global
// Fig. 2
// Open input files and read data
// Steps 3 and 4, 8 and 11
open (data 1);
read (data 1);
open (data 2);
read (data 2);
// Fourier transform data
// Steps 8 and 11
ft1 = fftw (data 1);
ft2 = fftw (data 2);
// Calculate the new metric
// (FSI, FRI, CIV, TIE...), here only named fsi
// Steps: 23
// Calculate Fourier shell/ring correlation
loop r, shell/ring;
  fsc (r) = correlate (r) (ft1, ft2);
end loop;
// Calculate new Fourier space metrics
loop r, shell/ring;
  fsi (r) = fsc to fsi (fsc(r));
  fsi_r_weighted (r) = fsi_to_r_weighted_fsi (fsi(r));
end loop;
// Estimate the resolution using the new metric
// (FSI, FRI, CIV, TIE...)
// Fig. 6 and 7
if resolution {
  threshold = fsi_limit (fsi(r));
}
if resolution {
  fsi->curve (fsi, threshold, curve);
  fsi_r_weighted->curve (fsi, threshold, curve);
} else {
  fsi->curve (fsi, curve);
  fsi_r_weighted->curve (fsi, curve);
}
// Store results
// Step 27
open (global fsi);
if resolution {
  write (fsi, curve, resolution);
} else {
  write (fsi, curve);
}
close (global fsi);
// Print results
// Step 30
print (fsi);
display (curve);
// end global
```

b) Local information—(aspect 3) and local resolution comparison (aspect 4):

```
// program local
// Fig. 4
// Open input file and read full-resolution data
// Steps 3-7
open (full-data);
read (full-data);
// Open input files and read sub-data
// Steps 6 and 7
open (sub-data 1);
read (sub-data 1);
open (sub-data 2);
read (sub-data 2);
// Fourier transform sub-data
// Fig. 2
ft1 = fftw (sub-data 1);
ft2 = fftw (sub-data 2);
// Locally compare and calculate new metrics
loop x, 1, length;
  loop y, 1, width;
    loop z, 1, height;
      // Window the sub-data
      // Steps 10 and 33
      create window (ft1, x, y, z)
      create window (ft2, x, y, z);
      // Calculate the new metric
      // (FSI, FRI, CIV, TIE...) here only named fsi
      // Step 20 and Fig. 2
      // Calculate Fourier shell/ring correlation
      // between windows
      loop r, shell/ring of window;
        fsc_in_window (r)
          = correlate (r) (window1, window2);
      end loop;
      // Calculate new Fourier space metrics
      loop r, shell/ring of window;
        local_fsi (r)= fsc_to_fsi (fsc_in_window(r));
        local_fsi_r_weighted(r)
        = fsi_to_r_weighted_fsi (fsc_in_window (r));
      end loop;
      if (resolution) {
        local_fsi_r_weighted(r)
            ->information_map(x,y,z);
      }
    end loop;
  end loop;
end loop:
// Store local comparison / information results
// Step 34
open (local fsi);
write (fsi, fsi_r_weighted);
close (local_fsi);
// Store information map
// Step 35
if (resolution) {
    open (information_map);
    write (information_map);
    close (information_map)
}
// Print results
// Steps 39 and 47
print (local_fsi);
print (local_fsi_r_weighted);
// Create and display information color mapped data
// Steps 39 tom 42
  if (resolution) {
    resolution_map->colors;
    display (full_data, colors);
}
// end local
```

### EXAMPLE EMBODIMENTS

Disclosed and described below are various embodiments and examples of the Systems, Devices, Components, and Methods for Optimizing Information and Data Acquisition, Transmission, Processing, and Analysis described and disclosed herein. These embodiments are illustrative, and not intended to be limiting.
1) A first example embodiment is configured to assess the information harvested on an object as a whole (globally). Output are curves based on the new Fourier information metrics.

Input data are any kind of 3D density maps (volumes), 2D images, 1D signals or related data. The input data is separated in two half-dataset groups which are summed. The two sums are Fourier transformed and then correlated in shells, rings, or . . . , in Fourier space. Using these correlations, the new Fourier space metrics FSI, FRI, TIE or . . . are calculated. The results are shown as curves and are printed as values.
2) A second example embodiment is configured to assess the global results resolution as well as the global integrated information content achieved on the object of interest from the harvested data. Output is a global resolution value and a total amount of collected information based on the new Fourier information metrics and integrated global information value:

Input data are any kind of 3D density maps (volumes), 2D images, 1D signals or related data. The input half-datasets are Fourier transformed. The data sets are then compared in shells, rings . . . in Fourier space. Using these correlations, the new Fourier space metrics FRI, FRI, TIE or . . . are calculated. The results are shown as curves and are printed values. The global resolution value(s) are calculated using the related new Fourier space metrics. The resolution value(s) are printed. The integrated information content is also calculated and printed.
3) A third example embodiment is configured to assess the local results resolution and the local integrated information content achieved for each sub-volume extracted from the object of interest from the harvested data. Output are curves based on the new Fourier information metrics:

Input are the full resolution data created from the full input available and sub-data created from (at least two) sub-sets of the input available. The sub-data sets are windowed and the new Fourier space metrics FSI, FRI or . . . is measured between the sub-data windows. The results are used to determine the resolution value for this window and also the local integrated information density. The procedure is iterated using the next window. For all windows chosen the local information curves are displayed and the integrated information values are printed.
4) A fourth example embodiment is configured to create local information maps of the data. Output are information map images/volumes based on the new Fourier information metrics:

Input are the full resolution data created from the full input available and sub-data created from (at least two) sub-sets of the input available. The sub-data are windowed and the new Fourier space metrics FSI, FRI or . . . is measured between the sub-data windows. The results are used to determine the resolution value for this window. The resolution value found is stored as density of a pixel in an information map image. The procedure is iterated using the next window. After having windowed the whole data the full resolution input data and the local information map are combined: the local information map values are color coded and the input data is displayed color-mapped by the local information.

A fifth example embodiment is configured to assess the efficiency and to measure the quality of cameras, detectors, transducers, and other signal detecting devices:
The cameras/detectors/transducers to be compared are prepared and adjusted using a standard procedure. Images, signals etc. are imaged/measured using a single or a set of standard test object(s) with the adjusted detectors/cameras/transducers. The measured data is globally compared (refer to 1^{st} and 2^{nd} aspect). The results are shown as graphics and printed as efficiency/quality values.

### FURTHER EXAMPLES OF APPLICATIONS

Disclosed and described below are further examples of applications in which the various embodiments may be employed. These examples are illustrative, and not intended to be limiting.
Global comparison:
   Cryo-EM 2D/3D density maps, X-ray 3D density maps
   Medicine: NMR, X-ray, CT, MRT . . .
   Other applications
Global information/resolution:
   Cryo-EM 2D/3D density maps
   Other applications
Local comparison:
   Cryo-EM 2D/3D density maps,
   Geophysical 3D earth crust analysis,
   Other applications
Local information/resolution maps:
   Cryo-EM 2D/3D density maps
   Medicine
   Other applications
Transducer efficiency/quality:
   Cryo-EM: Electron detector quality
   Photography: Camera quality
   Medicine: Detector quality of X-ray, CT, NMR and others
   Other applications

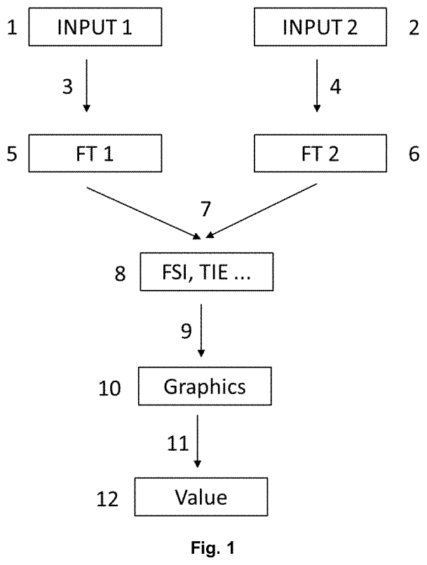

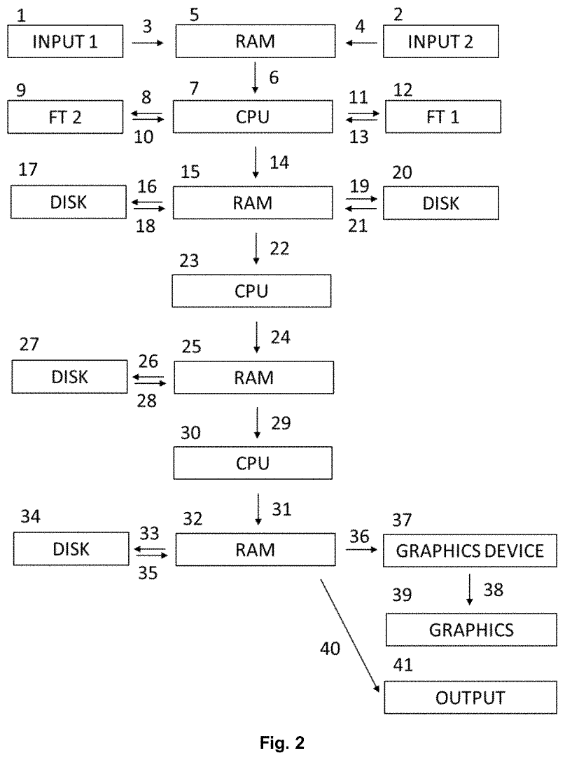

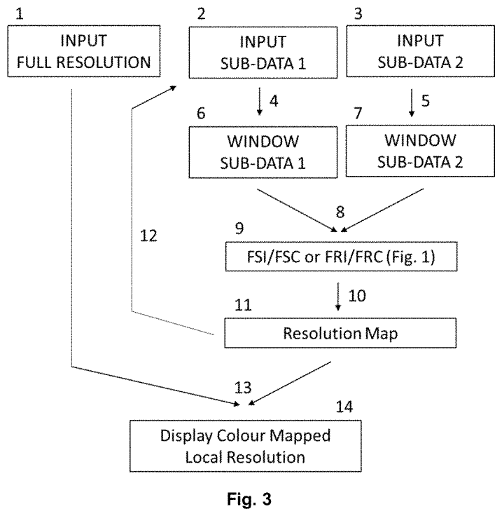

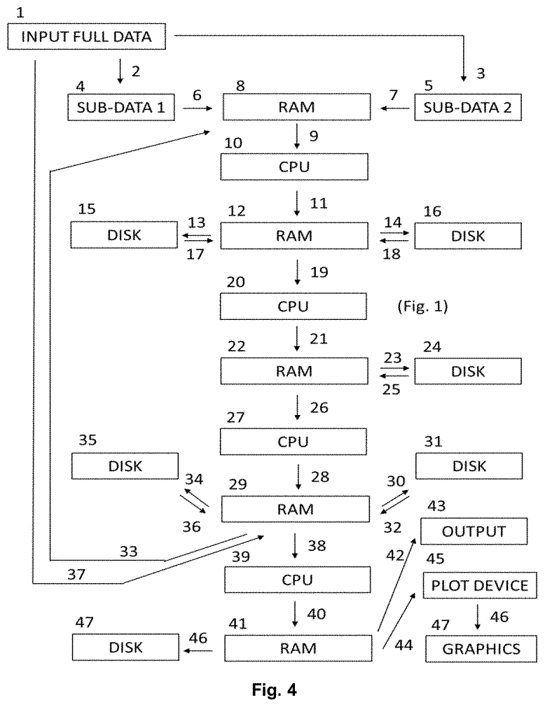

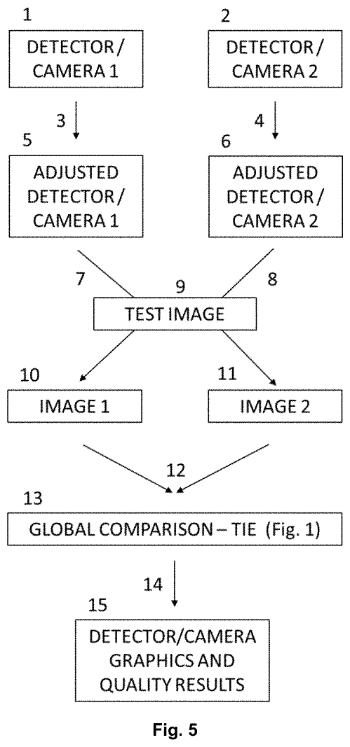

### DETAILED DESCRIPTIONS OF FIGS. 1-14

FIG. 1: Flowchart describing the new basic algorithm using the new Fourier space metrics for a global comparison. 1/2: Input data: 3D Volume, 2D Image, 1D Signal, . . . , 3/4: Fourier Transformation; 5/6: Fourier Transform of 3D Volume, 2D Image, 1D Signal; 7: Correlation; 8: New Fourier space metric FSI, FRI, TIE, . . . ; 9: Create Curve; 10: Plot Graphics; 11: Calculate Value; 12: Print Value.

FIG. 2: Flowchart describing the new basic algorithm using the new Fourier space metrics for a global comparison, detailing the relation steps involving hardware and software. 1/2: Input data: 3D Volume, 2D Image, 1D Signal, . . . , 3/4: Transfer to RAM; 5: RAM stores and handles the input; 6: Send input to CPU for calculation; 7: CPU calculate Fourier transforms or transfer input to FT device(s); 8/11: Transfer to FT device; 9/12: FT devices; 10/13: Transfer Fourier transforms to CPU; 14: Send Fourier transforms to RAM; 15: RAM stores and handles Fourier transforms; 16/19: Send Fourier transforms to storage device(s); 17/20: Store Fourier transforms on storage device(s); 18/21: Read Fourier transforms from storage device(s) if needed; 22: Send Fourier transforms to CPU for calculation; 23: CPU calculates new Fourier space metric FSI, FRI, TIE or . . . 24: Send results to RAM; 25: RAM stores and handles results; 26: Send results to storing device; 27: Store results on storing device; 28: Read results from storage device if needed; 29: Send results to CPU; 30: Calculate curves; 31: Send curves to RAM; 32: RAM stores and handles curves; 33: Send curves to storing device. 34: Store curves in storing device; 35: Read curves from storage device if needed; 36: Send curves to graphics/display/output device; 37: Store curves on graphics/display/output device; 38: Read curves on graphics/display/output device; 39: Show graphics on graphics/display/output device; 40: Send results to monitor/output device; 41: Print/show results.

FIG. 3: Flowchart describing the new basic algorithm for a local comparison. 1: Full resolution data: 3D Volume, 2D Image, . . . 2/3: 3D Volumes, 2D Images, . . . created from Sub-Data; 4/5: Create Window-Volume/Image (windowing); 6/7: Window-Volume/Image; 8: Calculate new Fourier space metric FSI, FRI or . . . (FIG. 1); 9: Resolution Value for Window-Volume/Image; 10: Store Value as Pixel in Resolution Map Image/Local Information Density; 11. Resolution Map Image/Local Information Density Image; 12: Continue with Window-Volume/Image; 13: Combine Full Resolution Input and Resolution/Information Density Map, Color code Resolution Values; 14: Display the Input coloured mapped by the Local Resolution or Local Information Density.

FIG. 4: Flowchart describing the new basic algorithm for a local comparison, detailing the relation steps involving hardware and software. 1: Input full data: 3D Volume/2D Image/1D Signal, . . . ; 2/3: Create sub-data 3D Volumes/2D Images/1D Signals, . . . ; 3/4: Sub-data 3D Volumes/2D Images/1D Signals, . . . ; 6/7: Transfer to RAM, 8: RAM stores and handles sub-data; 9: Send sub-data to CPU for calculation; 10: CPU create first/new windowed data; 11: Send windowed data to RAM; 12: RAM stores and handles windowed data; 13/14: Send results to storing device if needed; 15/16: Store results on storage device if needed; 17/18: Read results from storage device if needed; 19: Send windowed data to CPU; 20: CPU calculates global resolution/comparison, according to FIG. 1 using the windowed data; 21: Send results to RAM; 22: RAM stores and handles results; 23: Send results to storing device; 24: Store results on storing device; 25: Read results from storage device if needed; 26: Send results to CPU; 27: Update the resolution map; 28: Send updated resolution map to RAM; 29: RAM stores and handles updated resolution map; 30: Send updated resolution map to storing device if needed; 31: Store updated resolution map in storing device if needed; 32: Read updated resolution map from storing device if needed; 33: Re-do the calculations with the next windowed data; 34: Send final resolution map to storing device if finished; 35: Store final resolution map on storing device; 36: Read final resolution map from storing device if needed; 37: Send full data 3D Volume/2D Image/1D Signal, . . . to RAM; 38: Send full data and final resolution map to CPU; 39: Calculate color mapped local resolution or local information density maps; 40: Send color mapped local resolution/information density maps to RAM; 41: RAM stores and handles color mapped local resolution/information density maps; 42: Send results to monitor/output device; 43: Print/show results on monitor/output device; 44: Send results to graphics/display/output device; 45: Store results on graphics/display/output device; 46: Read curves on graphics/display/output device; 47: Show graphics on graphics/display/output device.

FIG. 5: Flowchart describing the basic algorithm using the new Fourier space metrics for assessing the camera/detector transducer information efficiency, and using it as a metric for camera/detector/transducer quality. 1: Prepare camera/detector/transducer 1; 2: Prepare camera/detector/transducer 2; 3: Adjust detector/camera 1; 4: Adjust camera/detector/transducer 2; 5/6: Adjusted cameras/detectors/transducers; 7: Take images from test object (9) with adjusted camera/detector/transducer 1; 8: Take images from test object (9) with adjusted camera/detector/transducer 2; 9: Test object: A medical phantom, 3D test dummy, a noisy image of a Siemens star and/or . . . ; 10/11: Take Images from cameras/detectors/transducers to be compared; 12: Send images to global comparison—see FIG. 1; 13: Global comparison/TIE calculation—see FIG. 1; 14: Create TIE results output; 15: Show camera/detector/transducer graphics and efficiency/quality results.

FIG. 6: Flowchart describing the algorithm of the new Fourier space metrics to globally compare data and/or estimate the global resolution. 1/2: Input 3D Volumes, 2D Images, 1D Signals, . . . ; 3/4: Align and/or centre input data; 5: Alignment/Centring; 6: Aligned/centred input data 1; 7: Aligned/centred input data 2; 8: Send Aligned/centred input data to a global comparison (FIG. 1).

FIG. 7: Flowchart describing the algorithm of the new Fourier space metrics to globally compare data and/or estimate the global resolution or global integrated information content of an object, detailing the relation steps involving hardware and software. 1/2: Input 3D Volumes, 2D Images, 1D Signals, . . . ; 3/4: Transfer to RAM; 5: RAM stores and handles the data; 6: Send input data to CPU for calculation; 7: Align and/or centre input data; 8: Send aligned/centred data to RAM; 9: RAM stores and handles aligned/centred data; 10/11; Send aligned/centred data to storing device if needed; 12/13: Store aligned/centred data on storage device if needed; 14/15: Read aligned/centred data from storage device if needed; 16: Use aligned/centred data for a global comparison; 17: Calculate global comparisons (FIG. 2).

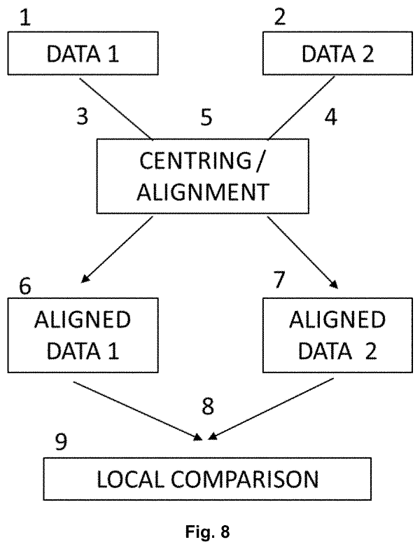

FIG. 8: Flowchart describing the algorithm of the new Fourier space metrics to locally compare the information density and/or estimate the local resolution. 1/2: Input 3D Volumes, 2D Images, 1D Signals, . . . ; 3/4: Align and/or centre input data; 5: Alignment/Centring; 6: Aligned/centred input data 1; 7: Aligned/centred input data 2; 8: Send Aligned/centred input data to a local comparison (FIG. 3).

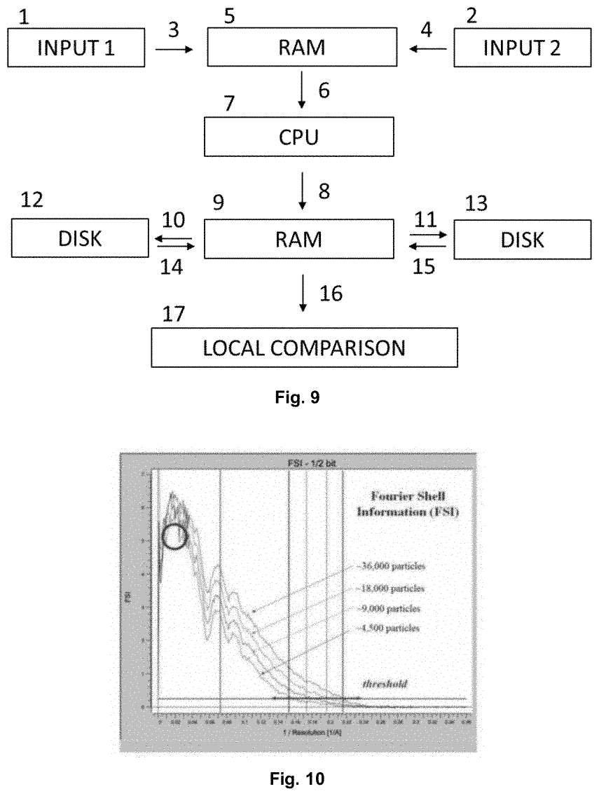

FIG. 9: Flowchart describing the algorithm of the new Fourier space metrics to locally compare data based on the local information density and/or to estimate the local resolution, detailing the relation steps involving hardware and software. 1/2: Input 3D Volumes, 2D Images, 1D Signals, . . . ; 3/4: Transfer to RAM; 5: RAM stores and handles the data; 6: Send input data to CPU for calculation; 7: Align and/or centre input data; 8: Send aligned/centred data to RAM; 9: RAM stores and handles aligned/centred data; 10/11; Send aligned/centred data to storing device when needed; 12/13: Store aligned/centred data on storage device when needed; 14/15: Read aligned/centred data from storage device when needed; 16: Use aligned/centred data for global comparison; 17: Calculate local information density (FIG. 4).

FIG. 10: Typical FSI curves are shown in this figure, these show the information content as function of the spatial frequency. The curves start at a very low level at the origin and gradually increase. The FSI at low resolution, however, still gives a too strong representation of the low-frequency data (circled).

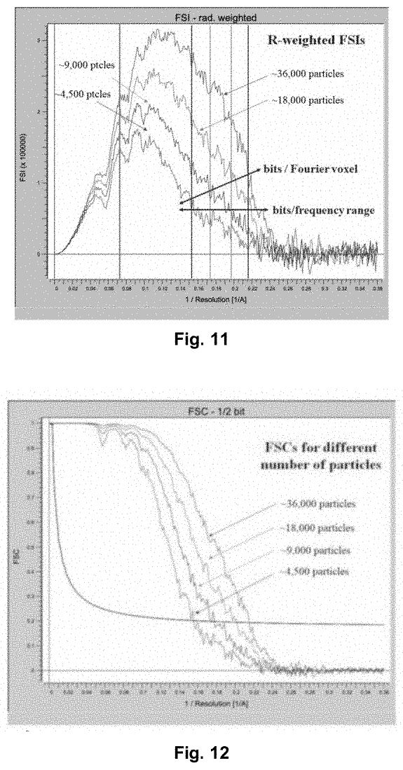

FIG. 11: Typical r-weighted FSI curves are shown in this figure, these show the information content as function of the spatial frequency. The curves start at a very low level at the origin and gradually increase, due to increasing information content within increasing radius. The different coloured FSI curves are the results of the global comparison of different 3D volumes and show that 3D volumes based on larger data-sets (i.e. more input particles that the 3D volume is created from) contain more information.

FIG. 12: Comparative example of the representation of an FSC curve. The FSC curve starts of close to the maximum value of 1 and gradually drops to a low value oscillating around the zero mark. Large oscillations close to the origin are due to the small number of voxels in that area. A threshold curve indicates where enough data was collected for a reliable interpretation (the ½-bit resolution threshold).

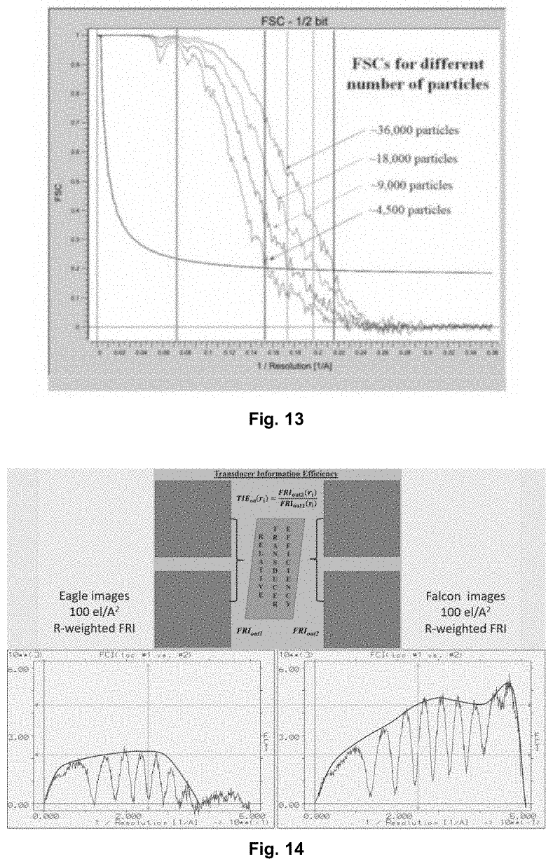

FIG. 13: Comparative example of FSC curves for four different groups of the data set (⅛^{th}, ¼^{th}, ½, and full dataset, calculated, with explanatory markings. The orange (1^{st} vertical line, left-to-right) shows maxima of the FSCs very close together close to the “1” maximum. The remaining vertical lines assist in the mutual comparison of the FSC, FSI and FSIr (r-weighted FSI) metric resolution thresholds.

FIG. 14: Fourier Ring Information FRI for two different cryo-EM cameras using the same test sample; both cameras were mounted on the same microscope. A) On the left-hand side is an accumulated FRIₒᵤₜ₁ over 10 different measurements, measured using an “Eagle” CCD camera (FEI). B) On the right-hand side: an accumulated FRIₒᵤₜ₂ also over 10 measurements, collected using a pre-production “Falcon II” CMOS camera. The FRI curves show the different efficiencies of the cameras and allow to directly compare their quality.

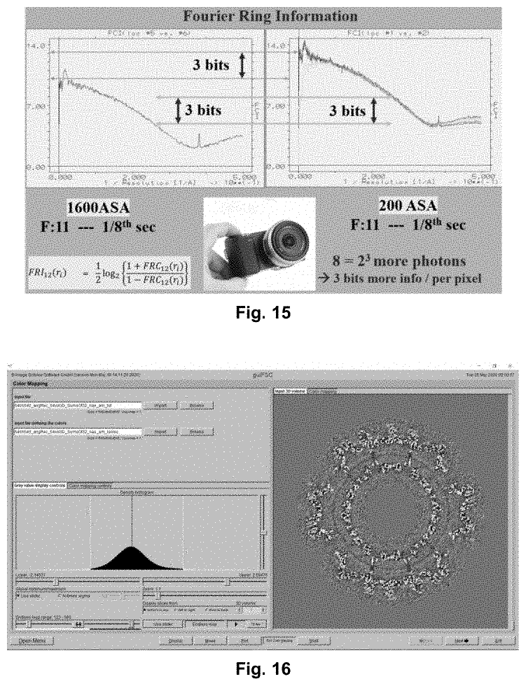

FIG. 15: The new Fourier space comparisons using the Transducer Information Efficiency TIE show that different exposure times lead to different information contents in the detected images.

FIG. 16: One page of the “guiFSC” software to calculate the global and local information comparisons. Displayed is a section of a cryo-EM three-dimensional density of a pathogenic human virus.

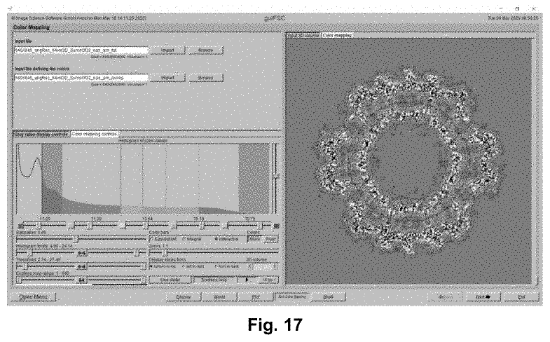

FIG. 17: A section of the three-dimensional density in FIG. 16 with the local information/resolution imposed as colors. Different colors represent different local information/resolution. In cryo-EM, for example, differences in local information/resolution can be used for structural interpretation of the biological object.

In view of the structural and functional descriptions provided herein, those skilled in the art will appreciate that portions of the described systems, devices, components, and methods may be configured as methods, data processing systems, or computer algorithms. Accordingly, these portions of the systems, devices, components, and methods described herein may take the form of a hardware embodiment, a software embodiment, or an embodiment combining software and hardware. Furthermore, portions of the systems, devices, components, and methods described herein may be a computer algorithm or method stored in a computer usable storage medium having computer readable program code on the medium. Any suitable computer readable medium may be utilized including, but not limited to, static and dynamic storage devices, hard disks, optical storage devices, and magnetic storage devices.

Certain embodiments of portions of the systems, devices, components, and methods described herein are also described with reference to block diagrams of methods, systems, and computer algorithm products. It will be understood that such block diagrams, and combinations of blocks diagrams in the Figures can be implemented using computer executable instructions. These computer executable instructions may be provided to one or more processors of a general-purpose computer, a special purpose computer, or any other suitable programmable data processing apparatus (or a combination of devices and circuits) to produce a machine, such that the instructions, which executed via the processor(s), implement the functions specified in the block or blocks of the block diagrams.

These computer executable instructions may also be stored in a computer readable memory that can direct a computer or other programmable data processing apparatus to function in a particular manner, such that the instructions stored in the computer readable memory result in an article of manufacture including instructions which implement the function specified in an individual block, plurality of blocks, or block diagram. The computer program instructions may also be loaded onto a computer or other programmable data processing apparatus to cause a series of operational steps to be performed on the computer or other programmable apparatus to produce a computer implemented process such that the instructions which execute on a computer or other programmable apparatus provide steps for implementing the functions specified in an individual block, plurality of blocks, or block diagram.

In this regard, the figures illustrate only a few limited examples of a computer system (which, by way of example, can include multiple computers or computer workstations) that can be employed to execute one or more embodiments of the systems, devices, components, and methods described and disclosed herein.

What have been described above and otherwise herein are examples and embodiments of the systems, devices, components, and methods described and disclosed herein. It is, of course, not possible to describe every conceivable combination of components or methodologies for purposes of describing the invention, but one of ordinary skill in the art will recognize that many further combinations and permutations of the systems, devices, components, and methods described and disclosed herein are possible. Accordingly, the systems, devices, components, and methods described and disclosed herein are intended to embrace all such alterations, modifications and variations that fall within the scope of the appended claims. In the claims, unless otherwise indicated, the article “a” is to refer to “one or more than one”.

The foregoing outlines features of several embodiments so that those skilled in the art may better understand the detailed description set forth herein. Those skilled in the art will now understand that many different permutations, combinations and variations of algorithms, methods, systems, devices, and components fall within the scope of the various embodiments. Those skilled in the art should appreciate that they may readily use the present disclosure as a basis for designing or modifying other methods, algorithms, processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

After having read and understood the present specification, those skilled in the art will now understand and appreciate that the various embodiments described herein provide solutions to long-standing problems, and provide significant benefits and advantages.

1. A system configured to, based on one or more data sets in any dimension of at least one object, provide information content in any form of representation or visualization comprising:
(a) at least one computing device, and
(b) at least one data acquisition device of any kind, configured to provide as outputs therefrom first and second data sets associated with at least one object,
wherein the computing device is configured to
(i) receive the acquisition data sets, either available as Real space or Fourier space data;
(ii) perform respective Fourier transforms, if necessary, over at least portions of the input data sets for the information and resolution assessment;
(iii) evaluate respective Fourier transforms of at least one of the data sets using the information content determination algorithm to generate output representative of the differences between data, using the formula
$${FRI}_{12} ( {r}_{i} ) = K \cdot {log}_{2} \{ \frac{1 + F R {C}_{12} ( {r}_{i} )}{1 - F R {C}_{12} ( {r}_{i} )} \}$$
for two-dimensional data sets,
$${FSI}_{12} ( {r}_{i} ) = K \cdot {log}_{2} \{ \frac{1 + F S {C}_{12} ( {r}_{i} )}{1 - F S {C}_{12} ( {r}_{i} )} \}$$
for three- or multi-dimensional data sets,
$${FI}_{12} ( {x}_{i} ) = K \cdot {log}_{2} \{ \frac{1 + F {C}_{12} ( {x}_{i} )}{1 - F {C}_{12} ( {x}_{i} )} \}$$
for one-dimensional data sets.

2. The system of claim 1, wherein the system is further configured to provide a visual representation to a user of the information content output.

3. The system of claim 2, wherein the visual representation provided to the user is color coded to represent differences in the visualized information content output.

4. The system of claim 2, wherein the differences in the visualized representation correspond to changes in properties or characteristics of the object.

5. The system of claim 4, wherein the properties or characteristics are one or more of biological, physical, chemical, magnetic, nuclear, and structural.

6. The system of claim 1, wherein the system is further configured to permit a user to selectably change information content thresholds in the information content output.

7. The system of claim 1, wherein the system is further configured to permit a user to selectably change colors in the information content output.

8. The system of claim 1, wherein the system is further configured to align at least portions of the input data sets before generating the transformed data sets.

9. The system of claim 1, wherein the system further comprises: a display, screen, or monitor operably connected to at least one computing device and configured to visually display to a user the at least one representation of the data set corresponding to, at least portions of the information content output.

10. The system of claim 1, wherein the system is further configured to estimate the information content output by using at least one or more portions of the sums of the data, rather than the data directly, for generating the information content output.

11. The system of claim 10, wherein the estimated resolutions are global or local.

12. The system of claim 1, wherein the system is further configured to estimate a quality or efficiency of at least one of the data acquisition device using at least portions of the information content output.

13. The system of claim 1, wherein the system is adapted and configured for use in one or more of the following applications: (a) electron microscopy; (b) light microscopy (c) atomic force microscopy (d) other microscopies (e) photography; (f) medical imaging, including X-ray, MRI, MT, NMR, and CAT-scan imaging; (g) geophysical data processing, including seismic data processing; (h) remote sensing, including remote earth sensing; (i) information communication, including optical fiber, electromagnetic, magnetic, electrical, radio, wired, wireless, LAN, WAN, and internet applications; (j) image processing; (k) image analysis; (l) image display; (m) information or data processing; (n) information or data analysis; and (o) information of data display.

14. The system of claim 1, wherein the system is further configured to generate at least one Transducer Information Efficiency TIE metric for at least the data acquisition device, where the TIE metric is calculated using the formula
$$TIE ( {r}_{i} ) = \frac{{FRI}_{o u t} ( {r}_{i} )}{{FRI}_{i n} ( {r}_{i} )}$$
for two-dimensional data sets,
$$TIE ( {r}_{i} ) = \frac{{FSI}_{o u t} ( {r}_{i} )}{{FSI}_{i n} ( {r}_{i} )}$$
for three- or multi-dimensional data sets,
$$TIE ( {x}_{i} ) = \frac{{FI}_{o u t} ( {x}_{i} )}{{FI}_{i n} ( {x}_{i} )}$$
for one-dimensional data sets.

15. A method, based on one or more data sets in any dimension of at least one object, to provide information-content output in any form of representation or visualization, comprising:
(a) receiving input data sets, either available as Real space or Fourier space data, from a computing device acquisitioning the input data sets associated to at least one object, the data sets being provided by any kind of data acquisition device;
(b) executing instructions stored in the computing device to generate the at least one information content output, the computing device being configured to
(i) receive the acquisition data sets either available as Real space or Fourier space data thereto;
(ii) perform respective Fourier transforms, if necessary, over at least portions of the input data sets for the information and resolution assessment and
(iii) evaluate respective Fourier transforms of at least one of the data sets using an information content determination algorithm to generate output representative of information content, resolution and differences between data using the formula:
$${FRI}_{12} ( {r}_{i} ) = K \cdot {log}_{2} \{ \frac{1 + F R {C}_{12} ( {r}_{i} )}{1 - F R {C}_{12} ( {r}_{i} )} \}$$
for two-dimensional data sets,
$${FSI}_{12} ( {r}_{i} ) = K \cdot {log}_{2} \{ \frac{1 + F S {C}_{12} ( {r}_{i} )}{1 - F S {C}_{12} ( {r}_{i} )} \}$$
for three- or multi-dimensional data sets,
$${FI}_{12} ( {x}_{i} ) = K \cdot {log}_{2} \{ \frac{1 + F {C}_{12} ( {x}_{i} )}{1 - F {C}_{12} ( {x}_{i} )} \}$$
for one-dimensional data sets.

16. The method of claim 15, further comprising providing a visual representation to the user of the information content output.

17. The method of claim 15, wherein the visual representation provided to the user is color coded to represent differences in the visualized information content output.

18. The method of claim 16, wherein the differences in the visualized representation correspond to changes in properties or characteristics of the object.

19. The method of claim 18, wherein the properties or characteristics are one or more of biological, physical, chemical, magnetic, nuclear, and structural.

20. The method of claim 15, further comprising selectably changing information content thresholds in the information content output.

21. The method of claim 15, further comprising changing selectably colors of the information output.

22. The method of claim 15, further comprising aligning at least portions of the first and second input data sets before generating the first and second Fourier transformed datasets.

23. The method of claim 15, further comprising visually displaying the at least one representation of, or data, data set, or signals corresponding to, at least portions of the information content output.

24. The method of claim 15, further comprising estimating the information content by using at least one or more portions of the sums of the data, rather than the data directly, for generating information content output.

25. The method of claim 15, further comprising estimating one or more global or local resolutions of at least one of the first and second input images or the first and second input data using at least portions of the information content output.

26. The method of claim 15, further comprising estimating a quality or efficiency of at least one of the data acquisition device using at least portions of the information content output.

27. The method of claim 15, further comprising generating at least one Transducer Information Efficiency TIE metric for the data acquisition device using at least partially the generated information content output where the TIE metric is calculated using the formula
$$TIE ( {r}_{i} ) = \frac{{FRI}_{o u t} ( {r}_{i} )}{{FRI}_{i n} ( {r}_{i} )}$$
for two-dimensional data sets
$$TIE ( {r}_{i} ) = \frac{{FSI}_{o u t} ( {r}_{i} )}{{FSI}_{i n} ( {r}_{i} )}$$
for three- or multi-dimensional data sets
$$TIE ( {x}_{i} ) = \frac{{FI}_{o u t} ( {x}_{i} )}{{FI}_{i n} ( {x}_{i} )}$$
for one-dimensional data sets.

28. The method of claim 15, further comprising adapting and configuring the method for use in one or more of the following applications: (a) electron microscopy; (b) light microscopy (c) atomic force microscopy (d) other microscopies (e) photography; (f) medical imaging, including X-ray imaging, MRI, MT, NMR, and CAT-scan imaging; (g) geophysical data processing, including seismic data processing; (h) remote sensing, including remote earth sensing; (i) information communication, including optical fiber, electromagnetic, magnetic, electrical, radio, wireless, LAN, WAN, and internet applications.

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)
